(19) United States
(12) Patent Application Publication
(10) Pub. No.: US 2004/0005452 A1
(43) Pub. Date: Jan. 8, 2004

(54) High temperature spray dried composite abradable powder for combustion spraying and abradable barrier coating produced using same

(76) Inventors: Mitchell R. Dorfman, Smithtown, NY (US); James Mallon, Deer Park, NY (US); Richard K. Schmid, Melville, NY (US)

Correspondence Address: Clifford Chance US LLP, 200 Park Avenue, New York, NY, 10166-0153, US

(21) Appl. No.: 10/341,912

(22) Filed: Jan. 14, 2003

Related U.S. Application Data
(60) Provisional application No. 60/348,484, filed on Jan. 14, 2002.

(51) Int. Cl. B32B 5/16; C23C 4/00; B05D 1/08

(52) U.S. Cl. 428/323; 427/446; 428/328

(57) ABSTRACT

An improved method of forming an abradable thermal barrier coating comprises providing a spray-dried powder of M-CrAlY and a solid lubricant, such as CoNiCrAlY—BN. Unlike powders provided for use with plasma spray guns, the powder is essentially free of polyester or other organic fugitive additives provided to increase porosity. The powder is applied using a combustion spray process and results in a M-CrAlY abradable coating that has an average porosity comparable to that of a plasma-applied coating but with smaller and more uniform pore distribution, and without requiring post-application heat treatments to remove fugitive materials. Deposition efficiency is also increased.

### CROSS-REFERENCE TO RELATED APPLICATIONS

The present invention claims priority under 35 U.S.C. § 119 to U.S. Provisional Patent Application Serial No. 60/348,484 entitled “Combustion Spraying Of High Temperature Spray Dried Composite Abradable Powder,” filed on Jan. 14, 2002, the entire contents of which is hereby expressly incorporated by reference.

### FIELD OF THE INVENTION:

This invention is related to methods for producing an abradable barrier coating and, more particularly, to a powder which can be applied to an object using a combustion spray process to produce an abradable coating, a method for applying the powder, and the resulting coating.

### BACKGROUND

Thermal spray powders are well known and are used to form coatings that protect and/or enhance the surfaces of various objects. Typically these coatings are applied to shroud segments in aerospace and gas turbine components although they can also be applied to other substrates. The substrates are typically either stainless steel or nickel/cobalt based superalloys. An intermediate oxidation resistant bond coat material can also be applied to enhance the bond between the substrate and abradable top coat.

The primary function of coatings of this type is allow for small gaps between adjacent moving parts, such as the tip of a turbine blade and the out casing/shroud, in order to increase system efficiency. In performing this function, the coating must provide certain protective features to the object, such as heat or chemical resistance. Powers are applied using various high-temperature spray guns which melt the powder grains as they are applied to the object to be coated. Known thermal spray gun technologies include high velocity combustion, plasma, electric arc, and low velocity combustion. Different types of gun technology eject the particles at different velocity and at different temperatures.

A particular type of coating is an abradable coating which is designed to provide certain protective features to the coated object, such as heat or chemical resistance, while also being abradable so as to permit the coating to wear without compromising the structural integrity of the coating and exposing the underlying object or releasing particles which are large enough to damage surrounding components. Abradable coatings are typically used to coat the engine shroud in aerospace and industrial gas turbine engines where minimizing the clearance between the blade tip and casing is critical to increasing engine efficiency. The reduction of the blade tip to casing clearance can result in the blades rubbing against the shroud. By coating the shroud with an abradable coating, this interaction can be accommodated as the thermally sprayed coatings release fine wear debris when machined by the blade without causing blade wear. Abradables are also used in other rotating equipment, such as stationary gas turbines, turbocompressors and pumps. Abradable coatings are generally more porous and less dense than comparable nonabradable coatings.

Many coatings are applied using a plasma gun. Because of the high velocity and high temperatures associated with plasma, coatings can be dense and difficult to abrade. Coating macro hardness will also be high (greater than R_{15Y} 80). To reduce the density, conventional practice is to mix the powder with an organic fugitive material. The powder is then applied with the plasma gun using spray parameters that allows the fugitive material to survive the spray process and become entrapped within the coating. The fugitive material is later removed by heat-treatment steps leaving generally uniform voids or pores in the coating.

A typical organic fugitive material added is a high temperature polymer such as polyester at about 15% by weight. A conventional abradable powder of this type used today in industrial gas turbine applications is a CoNiCrAlY/BN-Polyester. Such products (distributed for use with plasma spray technology) include Sulzer Metco 2042 and 2043 (Co 25 Ni 16 Cr 6.5 Al 0.5 Y with 14% polyester 7 BN and 15% polyester 7 BN, respectively). Powders of this type are discussed in U.S. Pat. Nos. 5,196,471 and 5,434,210, the entire contents of which are incorporated by reference.

One drawback to the use of these materials and methods is the need for the final heat treatment to remove the fugitive material. It often is not practical or desirable to heat treat the coated object. For example, some products are too large to fit in a conventional heat treatment oven or cannot easily be transported to an oven. In addition, the high temperature heat treatment may effect the quality of the applied coating or of surrounding uncoated areas. The added polymers also increase the cost of the spray powder.

As an alternative to plasma coatings which need polymers to generate controlled porosity, a combustion coating process can be used. In this process, a combustion flame spray torch is used in which a fuel gas and oxygen are fed through the torch and burned with the coating material in a powder or wire form and fed into the flame. The coating is heated to near or above its melting point and accelerated to speeds generally in the range of 30 to 90 m/s, generally much slower than the speeds of around 80-300 m/s provided by a plasma torch. The molten droplets impinge on the target surface where they flow together to form the coating. The combustion spray process allows control over the speed at which the powder particles are applied to the object. Using a low velocity spray, the particles impact the object at a slower speed and produce a lower density coating than would result using higher velocity processes, such as high velocity oxygen fuel or plasma.

Powders manufactured for use in plasma spray abradable applications have not generally been considered suitable for use in combustion spray techniques. In combustion spray processes, the applied particle speed is much lower than in plasma spraying. As a result, much of the polymer added to the plasma spray powder vaporizes before the molten powder impacts the surface to be coated. The vaporized polymer can interfere with the coating process and reduce the coating quality. In addition, the structure of the coating can vary, having large or small pores of varying distribution depending on whether some or all of the polymer was consumed before the particle stream was deposited on the substrate.

Conventional combustion powders for use in producing abradable coatings (e.g., powders to be applied using a combustion process) include graphite and NiCrAl bentonite products. However, unlike powders manufactured for use in plasma spray guns, products such as these are manufactured as “clad” composites wherein a solid lubricant or filler is encapsulated around an outside shell of nickel or NiCrAl. Clad materials can either be manufactured by chemical or mechanical techniques. Mechanical clad powders are essentially produced by mixing a core particle (e.g., graphite, BN) with a fine dispersion of metallic Ni, Al, Co, Fe and its alloys or ceramic powders in a pot with a binder. The fine powders are typically less than 22 microns in size and the core material is typically between −100+44 microns. The binder acts to glue the particles together. The liquid material is heated to evaporate off the liquid, resulting in the dried powder.

Cladding is used as a way of protecting a fugitive core material from the thermal spray environment and a way of minimizing thermal decomposition. Chemical clad materials are generally produced by the deposition of a metallic layer, typically 5 microns thick, around a core particle. Deposition is typically done using electrochemical or vapor deposition processes or a combination of the two. Representative clad products include Sulzer Metco 301 (Ni 14 Cr 8 Fe 5.5 BN 3.5 Al clad), Sulzer Metco 307 (Ni 25 Graphite clad), and Sulzer Metco 314 (Ni 4 Cr4 Al 21 calcined bentonite clay clad).

The deposit efficiency (“DE”) for high temperature Nickel/Cobalt clad compositions is typically on the order of 45% to 65% as compared to a typical DE of 30-50% for plasma. In addition, clad compositions generally produce “nonhomogeneous structures” with discrete phases of solid lubricants or fugitive materials (greater than 10 microns in size). Coatings produced using clad compositions also have non-uniform voids or pores, which can result in uneven wearing of the surface and other negative effects.

### SUMMARY OF THE INVENTION

According to the present invention, a powder comprising M-CrAlY and a solid lubricant is provided, where M is a metal, intermetallic compound, or oxidation alloy, and where the powder is essentially free of organic fugitive materials. The powder preferably includes a solid lubricant, such as boron nitride, and is spray-dried to form a relatively coarse powder having particles with an average size of greater than about 44 microns. Most preferably, the powder is CoNiCrAlY—BN.

Unlike known uses of M-CrAlY powder, which involve application using a plasma gun, the M-CrAlY is not mixed with an organic fugitive material, such as polyester, for the purposes of reducing the density of the coating. Instead, the powder is provided essentially free of organic fugitive material and is applied to a substrate using a lower velocity combustion gun. Advantageously, and unexpectedly, the resulting coating has a porosity of about 50%, comparable to that of a M-CrAlY coating applied using a plasma gun but without the time, expense, and other difficulties associated with a heat treatment of the coated object to remove fugitive materials and open the pores. In addition, the resulting coating has a finer porosity than comparable plasma-applied (and heat-treated) coatings, resulting in improved coating behavior, such as decreased and more even wear. Moreover, the deposit efficiency of this powder when applied using a combustion gun is on the order of 75% to 90%, compared with the DE for the plasma coating, which is on the order of 30% to 50%.

As a result, the present invention provides for unexpected improvements in the quality of a M-CrAlY abradable coating along with reduced cost and application time due to increased application efficiency and the elimination of post-application heat treatment.

### BRIEF DESCRIPTION OF THE DRAWINGS

FIGS. 1A and 1B are cross-sectional photomicrographs abradable coatings;

FIG. 2 is a chart showing comparative tests for various abradable coatings; and

FIG. 3 is a bar graph showing comparative wear for various abradable coatings.

### DESCRIPTION OF THE INVENTION

According to the invention, a high-temperature spray powder for use in forming abradable coatings is formed using a spray drying technique. The powder “base” is a composite of M-CrAlY and a solid lubricant, where M is a metal, such as one or more of nickel, cobalt, or iron. The base can also be an intermetallic compound, such as FeAl₃, NiAl, or Ni₃Al, or an oxidation alloy, such as iron (stainless steels), nickel (Ni—Cr, NiCrAl, or NiAl) or cobolt (Co—Al, Co—Cr, Co—Cr—Al). Preferably, M is CoNi. The solid lubricant is preferably boron nitride, and most preferably hexagonal boron nitride with a particle size of less than 44 microns, but can also be graphite, mica, calcium fluoride, or other solid lubricants known to those of skill in the art. The lubricant is generally between 1% and 20% by weight of the base mixture, more preferably between 5% and 15%, and, in a particular embodiment, 10% by weight. The composition is then formed into a powder using spray dry techniques, discussed in more detail below. The spray dried composite abradable powder for use in combustion spray should have a particle size distribution greater than 44 microns, and preferably between 250-44 microns. Powders with the preferred particle size will generate abradable coating microstructure with a high porosity, generally from 20% to 60% by volume.

Unlike conventional techniques, the spray powder is not mixed with polymer beads or other organic fugitive materials as is done when producing powder for use in a plasma torch. Instead, the powder is provided with substantially no additional materials added for use in a combustion spray process. The essentially polymer-free powder provides an alternative to the clad powders conventionally used for producing thermal coatings using a combustion gun.

The powder is used in a combustion spray process to produce an abradable coating. Although the spray-dried powder lacks the additional polymer or other sacrificial elements that are conventionally used to increase coating porosity in plasma spray applications, when applied using a combustion spray technique the powder unexpectedly produces a high-quality abradable coating. The coating is comparable to or better than that produced using similar powders containing organic fugitive materials and applied using plasma spray technology or using clad powders applied using combustion spray techniques. In particular, a coating produced by use of the powder in a combustion spray process according to the present invention has a finer porosity than a comparable coating applied using a plasma spray process and, as a result, will wear more uniformly and consistently and release a finer wear debris.

To produce the spray dried powder, a slurry or slip is formed of the base mixture, an organic binder, and a suitable liquid, preferably deionized water. The preferred binder used is CMC (carboxymethylcellulose). However, other binders known to those of skill in the art, such as PVA (polyvinylalcohol) or MC (methylcellulose), can alternatively be used. In a preferred embodiment, the slurry has between about 1% and 10% of binder by dry weight relative to the weight of base material in the slurry, preferably on the order of about 4%, and most preferably, substantially 4.0%.

Preferably, the water and binder are already formed in solution, such as a 25% solution of binder in water prior to the addition of the base material. Alternatively, the binder can be added to the water generally concurrently with the base material when forming the slurry. A dispersing agent, such as Nopcosperse, can also be added to aid in producing a uniform particle suspension in the slurry. Preferably, about 2% by dry weight of the suspension agent relative to the base is added to the slurry.

The slurry is atomized and spray dried using conventional spray-dry techniques. In the preferred embodiment, the resulting powder is then screened to a particle size between about 22 and 250 microns. Generally, powders with a coarse particle size distribution (−50 mesh +325 mesh) result in a coating microstructure with 20-40% porosity and with minimal interparticle oxidation. Powders with a particle size distribution under about 44 microns (−325 mesh) do not generally produce good abradable coatings using untipped blades because the coatings would be too dense, having porosity values typically under 20%.

Powders produced using the present method and having larger or smaller particles may be useful in other applications. Preferably, however, particles which are screened out are reused during the mixing of a subsequent slurry. Preferably, no more than about 30% of such recycled particles are added to the slurry.

The size of the spray-dry particles is affected by the viscosity of the slurry. It has been found that a viscosity of between 500 and 600 cps provides suitable results. The viscosity of the slurry can easily be adjusted prior to spray drying by adding additional water (or other suitable liquid) until the desired viscosity is reached. A rough measurement of viscosity is provided by use of a Zahn Kinematic Viscosity Cup #4. At the preferred viscosity, the cup will empty in about 21 to 24 seconds.

Advantageously, the final product is a more homeogeneous mixture with more uniform particle size than clad powders. Relative to clad powders, the spray dry powder of the present method has better flow. The deposit efficiency of the spray dry powder is typically 70%, comparable to or better than for comparable clad powders.

A most preferred embodiment of the powder is CoNiCrAlY—BN and is specifically discussed below.

The preferred (unprocessed) base is formed using CoNiCrAlY gas atomized powder and Boron Nitride which is mixed with a CMC binder. The specification for the preferred raw CoNiCrAlY powder is detailed in table 1:

TABLE 1

Percent by Weight

| Element | min | max |
|---|---|---|
| cobalt | balance | |
| nickel | 31.0 | 33.0 |
| chromium | 20.0 | 22.0 |
| Aluminum | 7.0 | 9.0 |
| Yttrium | 0.35 | 0.65 |
| Carbon | — | 0.02 |
| Sulfur | — | 0.01 |
| Total all others | — | 0.5 |

| | |
|---|---|
| oxygen | report |
| nitrogen | report |

The preferred particle size distribution of the source powder is as shown in Table 2:

TABLE 2

Percent by Weight

| Sieve | min | max |
|---|---|---|
| +325 mesh | — | 1 |
| −400 mesh | 95 | 100 |

The source powder preferably has the cumulative volume percentages shown in Table 3 when using a wet laser light scattering method:

TABLE 3

Percent by Weight

| Size | | min | max |
|---|---|---|---|
| −20 | microns | 32 | 58 |
| −10 | microns | 7 | 18 |
| −5 | microns | 7 | 18 |

The CoNiCrAlY powder is mixed with the Boron Nitride to a ratio of substantially 90% CoNiCrAlY to 10% BN. This base mixture is referred to herein as “CBN”.

A slurry is formed in deionized water of the CBN with substantially 4% CMC binder and preferably 2% Nopcosperse by dry weight relative to CBN. The mixture can also contain from zero to 30% by weight of off-size particles (too small or large) produced during a prior spray-dry process and removed, e.g., during a screening or other sizing process. Preferably, the CMC is provided via a 25% CMC solution in the water. The quantity of water in the slurry is adjusted until the viscosity of the slurry is between about 500 and 600 cps. The slurry is then spray dried using conventional techniques and processed using screening and/or other methods to remove off-size particles.

The resulting powder has an apparent density of substantially 2.0+/−0.2 gm/cc and has a composition as set forth in Table 4:

TABLE 4

Percent by Weight

| Element | min | max |
|---|---|---|
| cobalt | remainder | |
| nickel | 25 | 32 |
| chromium | 16 | 20 |
| Aluminum | 6 | 8.5 |
| Yttrium | 0.2 | 0.6 |
| Boron Nitride | 6 | 11 |
| organic binder | 2 | 5 |
| iron | — | 0.1 |

The powder preferably has a particle size of between about 250 and 22 micrometers and preferably greater than 44 micrometers. A screen analysis performed on a representative sample of the preferred embodiment has a cumulative distribution as shown in Table 5:

TABLE 5

Percent by Weight

| Mesh size | min | max | target |
|---|---|---|---|
| +100 | 10 | 16 | 13 |
| +140 | 23 | 30 | 27 |
| +200 | 40 | 50 | 45 |
| +230 | 50 | 62 | 55 |
| +270 | 57 | 68 | 62 |
| +325 | 63 | 73 | 68 |
| −325 | 27 | 37 | 32 |

A particle size analysis as measured by a dry laser light scattering method performed on a representative sample of the preferred embodiment has a distribution as shown in Table 6:

TABLE 6

Percent by Weight

| Micron | min | max | target |
|---|---|---|---|
| −248 | 92 | 100 | 96 |
| −176 | 75 | 85 | 80 |
| −125 | 54 | 66 | 60 |
| −88 | 38 | 50 | 44 |
| −44 | 12 | 20 | 16 |
| −31 | 5 | 10 | 7 |
| −22 | — | 4 | 2 |
| −11 | | 0 | 0 |

The spray powder can be used with a wide variety of spray guns. Preferably, the product is applied using a Sulzer Metco 6P-II series powder flame gun. A particular configuration of such a gun which is suitable for applying a powder produced according to the present method is shown in Table 7, discussed with respect to the example below.

This powder is preferably deposited so as to form a coating. The coating thickness can be selected as needed and is preferably up to 3 mm. The coating is suitable for application to substrates, such as shroud segments for aerospace and gas turbine components. Substrate materials are preferably stainless steel or nickel/cobalt based superalloys although other substrates can also be used. An intermediate oxidation resistant bond coat materials (typically from 0.13-0.25 mm thick) can be applied to enhance the bond between the substrate and abradable top coat. As discussed with respect to the examples below, the coating is abradable against steel and superalloy blades. However, the coating may also offer benefits to other types of blade materials (titanium). Unexpectedly, the powder according to the present invention provides for reduced cost and application time for similar or superior performance benefits as compared to existing plasma and combustion spray technology.

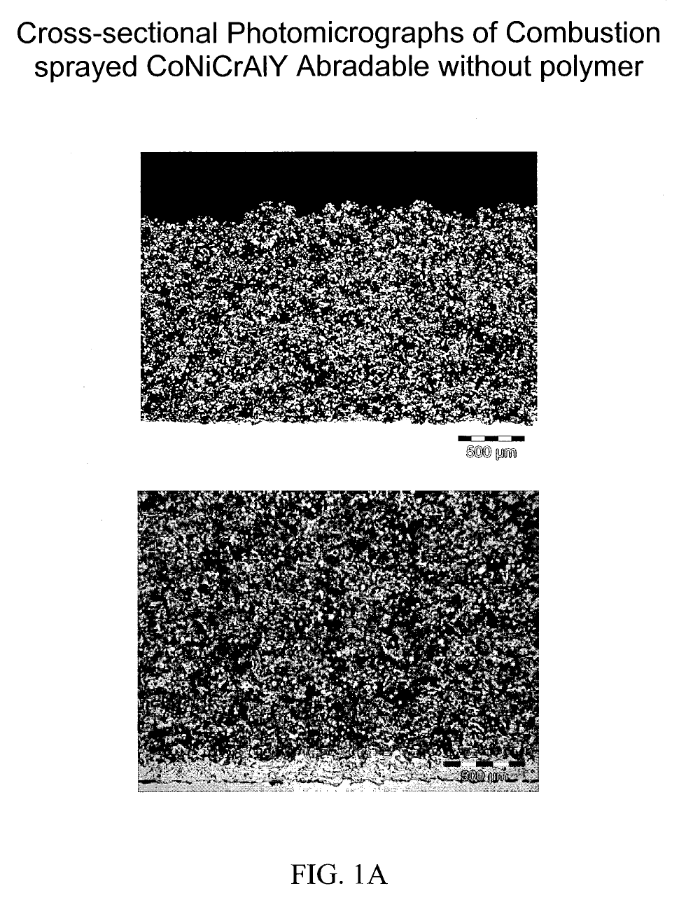

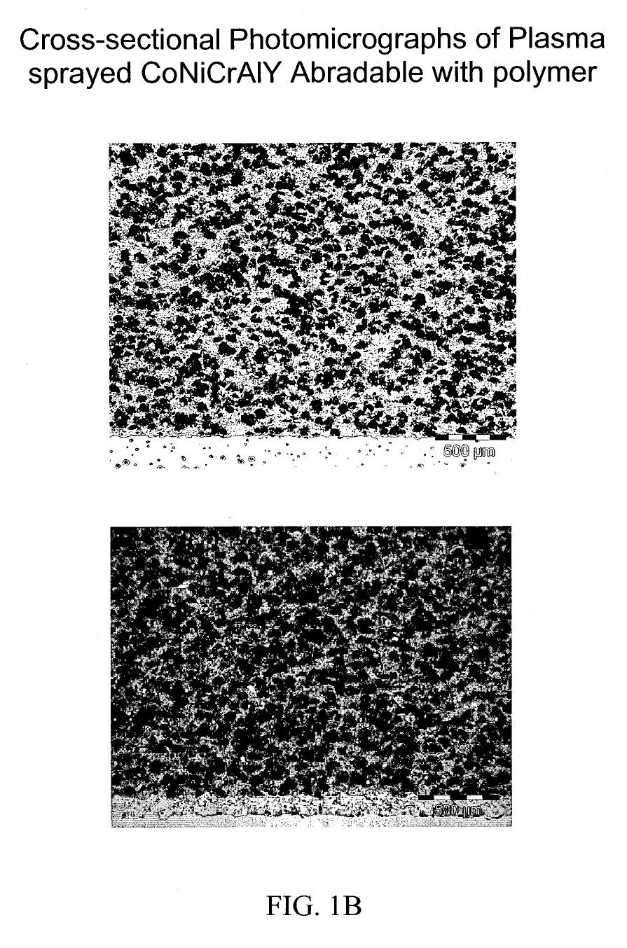

FIGS. 1a and 1b show 50× cross-sectional photomicrographs of plasma and combustion sprayed CoNiCrAlY abradable coatings. The powder used in the plasma spray process contained polymer material, as is conventional practice, while the additional fugitive materials were not added to the powder used during the combustion spray process. A specific version of this powder, but which is combined with polymer beads and only distributed for use in plasma spray applications, is available from as Sulzer Metco and identified as powders SM 2042 and SM 2043.

Unexpectedly, it has been found that the combustion coating according to the invention has several benefits. The combustion sprayed coating has an average porosity, measured using image analysis, which is comparable to that of the plasma sprayed coating: 50% vs. 48%. (The percentage of porosity in the new coating measured using oil impregnation technique is about 30-40%. Measurement of porosity using image analysis will typically result in higher measurements and is somewhat more subjective than oil an impregnation. However, even using oil impregnation, both coatings still have comparable porosity using either technique.)

The photomicrographs also clearly show that the combustion coating has a much finer porosity that that of the plasma coating. More particularly, the microstructure of the coating according to the invention can be characterized as being a fine, well-dispersed, spherical particle metal matrix with a high percentage of porosity that is well connected. The average size of the metal particles, as measured from the cross section of the coating, is 15-30 microns in the combustion sprayed coating. In the plasma sprayed CoNiCrAlY, the metal size is more difficult to determine due to the smaller size and because the particles are melted together and attached.

Through an image analysis of cross-section of these and similar micrograph cross-sections, the density of the SM2042 coating was measured at between 2.8 and 3.2 g/cc, the roughness as sprayed at between 13-15 microns and a porosity at between 50-60% volume. Comparatively, using the same techniques, the combustion sprayed coating according to the present invention had a density of between 2.9 and 3.3 g/cc, a roughness as sprayed of between 12-18 microns, and a porosity of between 45-60% volume. In addition, it has been found that the deposit efficiency of the powder using combustion coating is on the order of 75% to 90%, compared with the DE for the plasma coating, which is on the order of 30% to 50%.

Thus, although the two coatings have generally the same aggregate composition, density, and porosity, the size and structure of the porosity and the shape and size of the metal particles in the coating differs noticeably. In the plasma sprayed CoNiCrAlY+Polymer, the porosity is created by introducing polymer particles into the coating which are later burned out. This creates a void in the coating, which is rounded and may be separated by metal whereas the combustion sprayed abradable porosity is created through the spray process and is less defined and is well connected. Moreover, the DE using combustion spray of the no-polymer powder is considerably higher than that for plasma deposition. Therefore, the combustion coating is equal to or superior to the plasma coating and has the added benefit of reduced application cost, both in terms of an increased deposit efficiency, as well as the elimination of the costly and sometimes impracticable heat treatment to remove the organic fugitive materials.

### EXAMPLE

Three materials were selected for testing and comparison against each other. These materials included (a) AE8050 powder, a CoNiCrAlY—Bn powder without fugitive material, as discussed above, (b) SM 2042, CoNiCrAlY—Bn+Polyester, and (c) SM 307, a Nickel+Graphite clad powder. Four sample coatings of using AE8050 were prepared using a combustion spray process. In this example, an SM 6P-II series powder flame gun was used. Representative settings are shown in Table 7, below. The two preferred sample coatings were applied using a spray rate of 15 lbs/hour. A lower spray rate of 12 lbs/hour was used to prepare two additional sample coatings having substantially increased hardness.

Two sample coatings using SM307 were applied using a combustion spray process. Two sample coatings using the SM 2042 powder were applied using a plasma coating. The SM 2042 were not heat treated to reflect conditions wherein the coated part, due to cost or practical limitations, is not immediately heat treated but instead is allowed to be heat treated in operation as the engine operates (at high temperature).

The coatings were tested for hardness and abradability. The abradability testing was based on the following conditions that are encountered in a representative engine:

Blade tip velocity, 60 m/sec

Blade tip incursion rate, 3 μm/sec

Temperature, 200° C.

Blades, Stainless Steel (ALSI 422)

Blade Tip Thickness, 3.81

The primary results obtained from the abradability testing were incursion depth and blade wear. An image analysis of the abraded coating was performed. The results of the testing show that the AE 8050 coating of CoNiCrAlY—BN composite powder has a high porosity and favorable hardness.

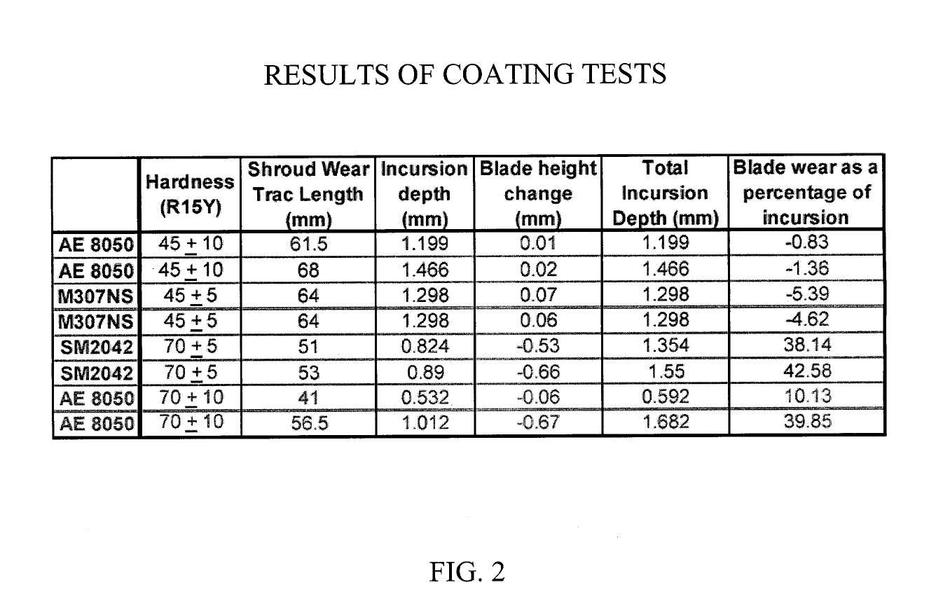

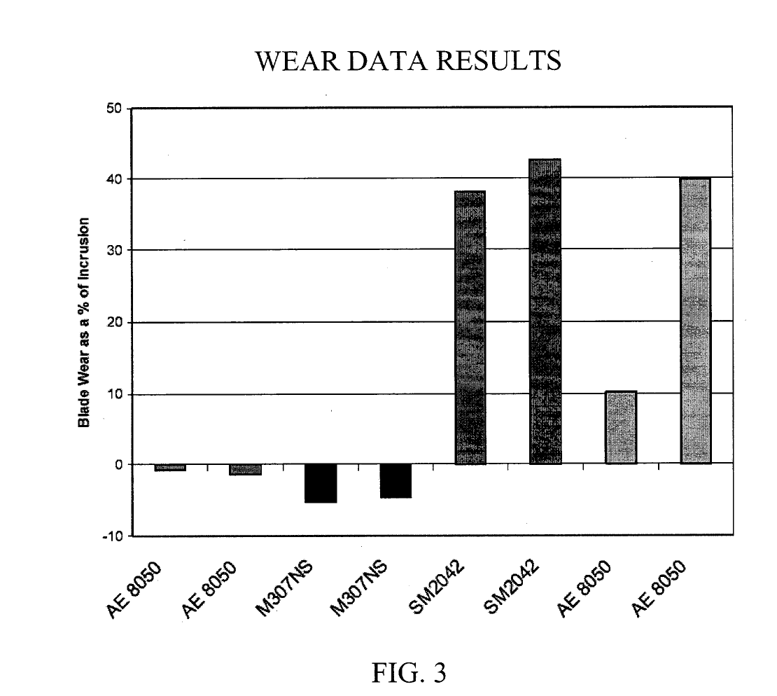

Detailed test results are shown in FIGS. 2 and 3. With reference to the first four entries (two for each coating type), it can be seen that the AE8050 (at 15 lbs/hour spray rate) and MN307 combustion coatings have a hardness, wear trac length, and incursion depth which are comparable. However, the blade wear of a coating according to the invention is substantially less than that of the conventional MN307 combustion coating.

In contrast, the hardness and blade wear of the SM2042 coatings were substantially greater. This resulted, at least in part, to the absence of heat treatment of the coating, a condition that occurs with some regularity in a real-world environment.

The last two AE 8050 coatings listed were applied using a 12 lbs/hour spray rate selected in order to increase the coating hardness. These coatings are much more comparable to the SM2042 coatings.

TABLE 7

| PARAMETER | VALUE USED IRESULTS | | | |
|---|---|---|---|---|
| [1] GUN | 6P-II | | 6P-II | |
| [2] AUXILIARY | 2 GF flowmeter | | 2 GF flowmeter | |
| EQUIPMENT | | | | |
| [3] NOZZLE | P 7CM | | P 7CM | |
| [4] SIPHON PLUG | 6P 605 | | 6P 605 | |
| [5] GAS P.S.I. & FLOW | O2: 40 psi., | 44 FMR | O2: 40 psi., | 44 FMR |
| [6] GAS P.S.I. & FLOW | Acetylene: 15 psi., | 50 FMR | Acetylene: 15 psi., | 50 FMR |
| [7] CARRIER P.S.I. & FLOW | N2: 55 psi., | 35 FMR | N2: 55 psi., | 35 FMR |

| | | |
|---|---|---|
| [8] SPRAY RATE [#/HR] | 15 #/ hr. | 12 #/ hr. |
| [9] FEED RATE INDICATOR | 100 | 100 |
| [10] SPRAY DISTANCE | 8.5″ | 8.5″ |
| [11] PICK UP SHAFT | B | B |
| [12] TRAVERSE RATE FT. / | 100 ft/min. (HV unit) | 100 ft/min. (HV unit) |
| MI. | | |
| [13] VERTICLE STEP | 1/8″ | 1/8″ |
| [14] AIR VIB. SETTING PSI. | 25 PSI | 25 PSI |
| [15] PREHEAT TEMP. | 150 F | 150 F |
| [16] D.E.% | N/A | N/A |
| [17] COATING TEMP. | 400° F. | 400° F. |
| [18] COATING THICKNESS | 0.080″ | 0.080″ |
| [19] COATING HARDNESS | R15Y: 37-56 | R15Y: 63-75 |
| [20] BOND STRENGTH | | |

COMMENTS Air cap ( 6P3-orient with cool side out). Air pressure: 15 psi.
0.008″-0.010″/ pass.

1. A method of forming an abradable barrier coating comprising the steps of:
providing a powder comprising M-CrAlY and a solid lubricant, where M is a metal, intermetallic compound, or oxidation alloy, and where the powder is essentially free of organic fugitive materials; and
applying the powder to a substrate using a combustion spray gun.

2. The method of claim 1, wherein M is selected singly or in combination from the group consisting of nickel, cobalt, iron, FeAl₃, NiAl, and Ni₃Al, stainless steel, Ni—CR, NiCrAl, NiAl, Co—Al, Co—Cr, Co—Cr—Al.

3. The method of claim 2, wherein M is CoNi.

4. The method of claim 1, wherein the lubricant is selected from the group comprising boron nitride, graphite, mica, and calcium fluoride.

5. The method of claim 4, wherein the lubricant is boron nitride.

6. The method of claim 1, wherein the powder is CoNiCrAlY—BN.

7. The method of claim 1, wherein the powder has an average particle size greater than about 44 micrometers.

8. The method of claim 1, wherein the powder is spray-dried.

9. A coating produced according to the method of claim 1.

10. An abradable coating comprising:
A layer of M-CrAlY not previously subjected to a heat treatment;
the layer being essentially free of organic fugitive materials.

11. The coating of claim 10, wherein the layer comprises metal particles having average sizes of between about 15 microns and about 30 microns, the layer having a porosity of between 45-60%, and the layer having a R_{15y} hardness of between about 30 and about 60.

12. The method of claim 1, wherein M is selected singly or in combination from the group consisting of nickel, cobalt, iron, FeAl₃, NiAl, and Ni₃Al, stainless steel, Ni—CR, NiCrAl, NiAl, Co—Al, Co—Cr, Co—Cr—Al.

13. The coating of claim 12, wherein M is CoNi.

14. A system for applying an abradable barrier coating comprising:
a combustion spray gun; and
a spray powder reservoir connected to the gun, the reservoir having therein a powder comprising M-CrAlY and a solid lubricant, where M is a metal, intermetallic compound, or oxidation alloy, and where the powder is substantially free of organic fugitive materials.

15. The system of claim 14, wherein M is selected singly or in combination from the group consisting of nickel, cobalt, iron, FeAl₃, NiAl, and Ni₃Al, stainless steel, Ni—CR, NiCrAl, NiAl, Co—Al, Co—Cr, Co—Cr—Al.

16. The system of claim 15, wherein M is CoNi.

17. The system of claim 14, wherein the lubricant is selected from the group comprising boron nitride, graphite, mica, and calcium fluoride.

18. The system of claim 14, wherein the powder is CoNiCrAlY—BN.

19. The system of claim 14, wherein the powder has an average particle size greater than about 44 micrometers.
